(19) United States
(12) Patent Application Publication
(10) Pub. No.: US 2011/0137945 A1
(43) Pub. Date: Jun. 9, 2011

(54) SYSTEM AND METHOD FOR ACCESSING BUILDING INFORMATION

(76) Inventor: Philip Mikael Sandblom, Toronto (CA)

(21) Appl. No.: 12/631,190

(22) Filed: Dec. 4, 2009

(51) Int. Cl. G06F 17/30

(52) U.S. Cl. 707/783; 707/E17.005

(57) ABSTRACT

A system and method for accessing building information, and a processor configured to control access to building information. In one broad aspect users and buildings form a network creating a building database comprising building related data for physical real world buildings. The processor is configured to determine the level of access for each user to each piece of building related data.

### FIELD

Embodiments described herein relate generally to computer-based systems and methods associated with providing users with varying authorization levels to access and contribute building related data.

### BACKGROUND

Typically, known methods of controlling the distribution of copyrighted drawings are based on printed copies. Professionals, such as architects and designers, normally strictly limit distribution of the electronic version of files and will issue paper copies to other professionals. More recently, electric forms of this exchange have evolved. Designers often convert files into an electronic format, such as a Portable Document Format (PDF) for distribution. However, this method has the same net effect as printing to paper since this format communicates the information to others but prevents reuse.

### SUMMARY

The embodiments described herein provide in one aspect, a system for exchanging building related data associated with a physical real world building amongst a first and second user, said system comprising:

(a) a processor;
(b) a building database for storing and maintaining the building related data associated with a physical real world building; and
(c) a physical computer readable memory storing computer executable instructions which, when executed by the processor causes the processor to:
(i) associate the first user with the physical real world building;
(ii) associate the second user with the physical real world building;
(iii) provide the first user and the second user with an authorization level to access the building database;
(iv) determine whether the authorization level of the first and second users allows them to access at least some of the building related data associated with the physical real world building;
(v) if in (iv) access is authorized, allow the exchange of building related data between a first user and a second user based on their mutual association through the physical real world building.

The embodiments described herein provide in another aspect, a method of exchanging building related data associated with a physical real world building amongst a first and second user, the steps of said method being stored on a physical computer readable memory, which when executed by a processor, perform the steps of:

(a) storing and maintaining a building database for the building related data associated with a physical real world building;
(b) associating the first user with the physical real world building;
(c) associating the second user with the physical real world building;
(d) providing the first user and the second user with an authorization level to access the building database;
(e) determining whether the authorization level of the first and second users allows them to access at least some of the building related data associated with the physical real world building;
(f) wherein, if in (e) access is authorized, allowing the exchange of building related data between a first user and a second user based on their mutual association through the physical real world building.

Further aspects and advantages of the embodiments described herein will appear from the following description taken together with the accompanying drawings.

### BRIEF DESCRIPTION OF THE DRAWINGS

For a better understanding of embodiments of the system and methods described herein, and to show more clearly how they may be carried into effect, reference will be made, by way of example, to the accompanying drawings in which:

FIG. 1 is a block diagram of an example implementation of a system for accessing building information;

FIGS. 2A, 2B, 2C and 2D are block diagrams of example user-building networks;

FIG. 3 is a block diagram describing one embodiment of the relationships between data elements in the building database of FIG. 1;

FIGS. 4 and 5 are block diagrams of exemplary navigation flows of the building information system of FIG. 1;

FIG. 6 is a flowchart illustrating an exemplary method of adding a building to the building information system of FIG. 1, in accordance with at least one embodiment;

FIG. 7 is a flowchart illustrating an exemplary method of a user contributing building related data to the building information system of FIG. 1, in accordance with at least one embodiment; and

FIG. 8 is flowchart illustrating an exemplary method of accessing building related data to the building information system of FIG. 1, in accordance with at least one embodiment.

The skilled person in the art will understand that the drawings, described below, are for illustration purposes only. The drawings are not intended to limit the scope of the applicants' teachings in any way. Further, where considered appropriate, reference numerals may be repeated among the figures to indicate corresponding or analogous elements.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

The embodiments of the systems and methods described herein may be implemented in hardware or software, or a combination of both. For example, some embodiments may be implemented in computer systems and computer programs, which may be stored on a physical computer readable medium, executable on programmable computers each comprising at least one processor, a data storage system (including volatile and non-volatile memory and/or storage elements), at least one input device (e.g. a keyboard or mouse), and at least one output device (e.g. a display screen, a network, or a remote server). For example and without limitation, the programmable computers may include servers, clustered servers, virtual machines, personal computers, laptops, netbook computers, personal data assistants (PDA), cell phones, smart phones, gaming devices, and other mobile devices.

In some embodiments, program code can be applied to input data to perform the functions described herein and to generate output information. The output information can then be supplied to one or more output devices for outputting to one or more users.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a physical computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

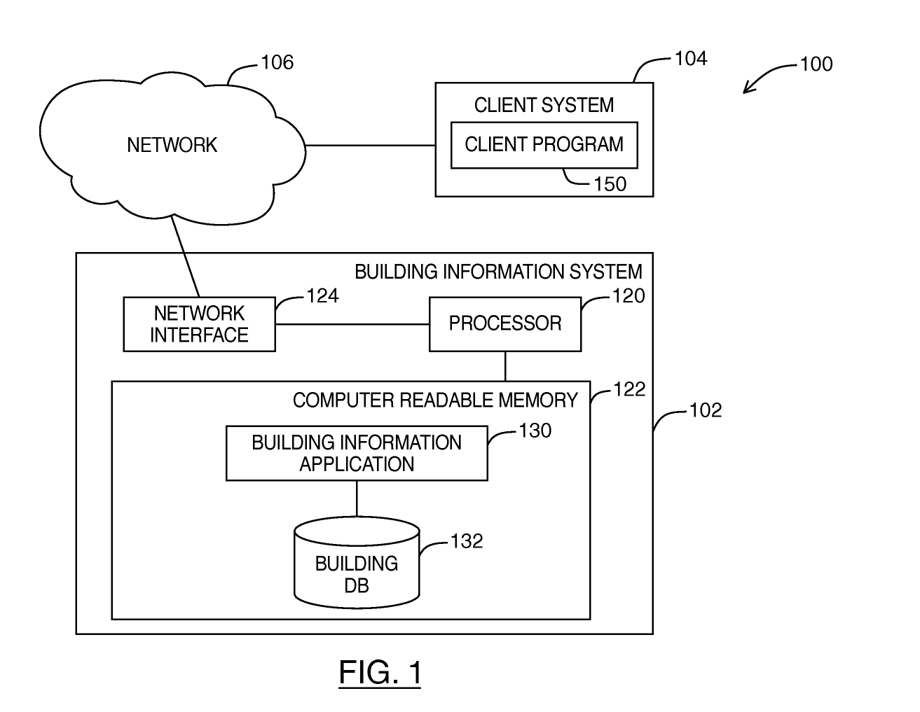

Referring now to FIG. 1, a block diagram of an example implementation of a system for accessing building information is shown generally as 100. Building information system 102 may comprise a main processor 120, operatively coupled to a physical computer readable memory 122 and a network interface 124. The physical computer readable memory 122 may store building information application 130 (containing instructions executable by processor 120), which may be operable to access building database 132. Building database 132 stores and maintains building related data. Client program 150 running on client system 104 may access building related data stored in building database 132 on building information system 102 by accessing building information application 130 through network 106.

In the preferred embodiment, building information application 130 may be a web-based application, incorporating the functionality of a web server application itself or communicating with a separate web server application (e.g., stored on physical computer-readable memory 122 or on computer-readable memory of another computer system). In such embodiments, client program 150 may be a web browser such as Microsoft® Internet Explorer® or Mozilla® Firefox®. Nevertheless, it will be understood that in alternate embodiments, client program 150 may access building information application 130 without utilizing web technology, communicating through other known methods of establishing communications between two computer systems known in the art.

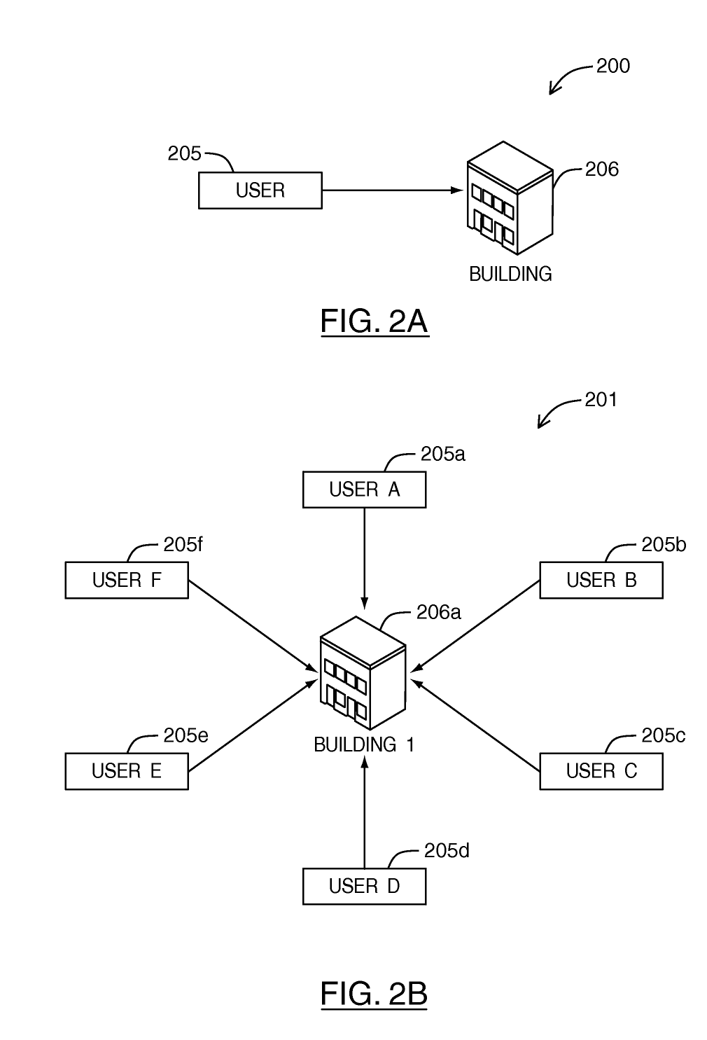

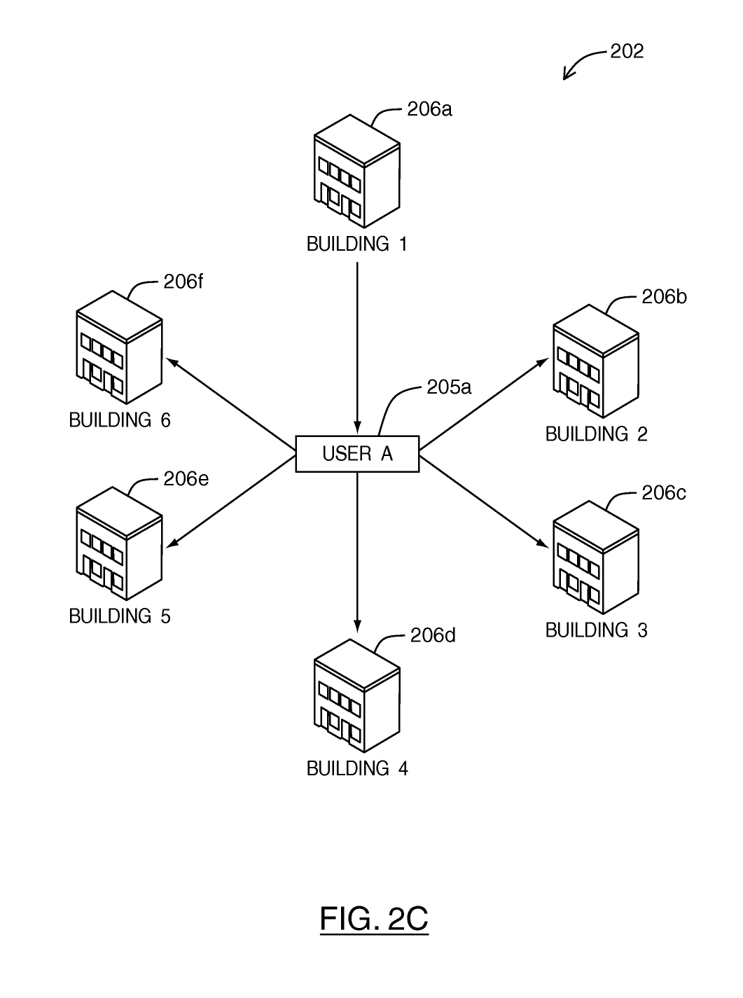

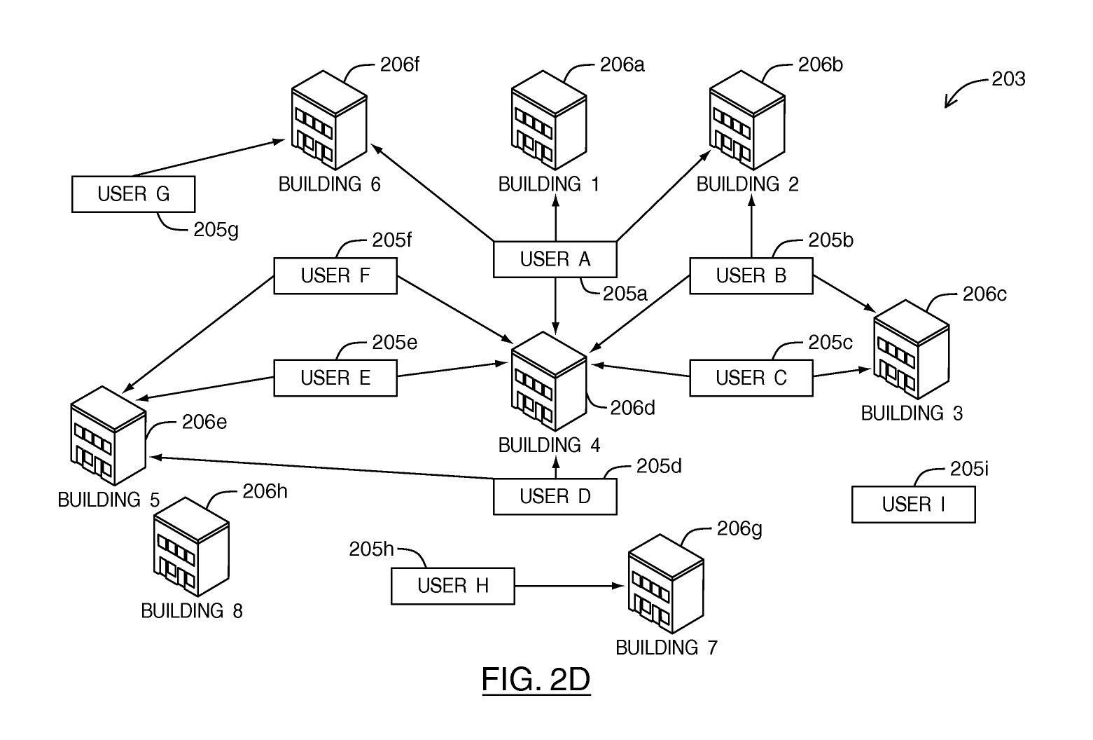

Building information application 130 utilizes certain associations between users and buildings and the specific building related data that they possess. Generally speaking building related data includes project information and/or building knowledge, some of which can relate to expertise and role of a user. Building related data may include building construction related data manifested in such items as, for example, paper based drawings and sketches, electronic drawings, diagrams and models in 2D or 3D, written specifications, manuals and instructions, change orders as well as photographs, written and electronic records of construction. Construction data may also include general knowledge and experience that consultants, contractors, owners, tenants and other people have acquired through their respective involvement with specific buildings. The associations between users and buildings are reflected in the ownership or creation of building related data stored by the building database 132. They may be represented by what will be referred to in this application as “a user-building network”. Exemplary user-building networks are displayed generally in FIG. 2A as 200, FIG. 2B as 201, FIG. 2C as 202, and FIG. 2D as 203.

FIG. 2A illustrates one exemplary embodiment of the system, where the user-building network 200 represents the association of a user 205 with a physical real world building 206. In this example, a user 205 possesses building related data such as expertise and knowledge about the physical real world building 206, and accordingly an association is constructed between the user 205 and the physical real world building 206. This user-building network 200 is an example of a basic user-building association, where only one user 205 is associated with only one physical real world building 206.

FIG. 2B illustrates another exemplary embodiment of the system, where the user-building network 201 is a more complex user-building network. The user-building network 201 comprises one physical real world building, Building 1 206a, and a plurality of users, namely Users A to F 205a to 205f. In this example, building database 132 stores the associations between Building 1 206a with a plurality of users, namely Users A through F 205a to 205f, each of which possesses building related data about Building 1 206a. In this example, an association is formed between each of Users A through F 205a to 205f and Building 1 206a. The illustrated associations are formed based on the relationships between the building related data associated with users and a physical real world building. As discussed above, this building related data could be, for example, project information or building knowledge. The associations represent the available building related data for Building 1 206a.

FIG. 2C illustrates another exemplary embodiment of the system, where the user-building network 202 consists of one user, User A 205a, and a plurality of physical real world buildings, Buildings 1 through 6 206a to 206f. In this example, User A 205a possesses building related data for a plurality of buildings, Buildings 1 through 6 206a to 206f. The illustrated associations are formed based on the relationships between the building related data associated with the user and the physical real world buildings. In this example, an association is formed between User A 205a and each of Buildings 1 through 6 206a to 206f. Again, the building knowledge and project information form the basis for this association. The associations represent the available building related data for User A 205a.

In a still further illustration, consider, for example, the user-building network 203 of FIG. 2D, which illustrates a more complex user-building network. In this example, the user-building network 203 comprises a plurality of users, Users A to I 205a to 205i, and a plurality of physical real world buildings, Buildings 1 to 8 206a to 206h. In this example, a complex user-building network is formed based on the complex and interconnected building related data associated with both the users and the physical real world buildings. For example, some physical real world buildings (e.g. Building 4 206d) is associated with building related data from a plurality of users (Users A through F 205a to 2050 while other physical real world buildings (e.g. Building 1 206a) have building related data from only a single user (User A 205a). Finally, other physical real world buildings (such as Building 8 206h) have no construction related data and form no association with any user.

Also, for example, some users (such as User A 205a) have building related data for a plurality of physical real world buildings (Buildings 1, 2, 4, and 6 206a, 206b, 206d, 206f) while other users (such as User G 205g) have building related data for a single physical real world building (Building 6 2060. Finally, other users (such as User I 205i) have no construction related data and form no association with any physical real world building.

Further, for example, the user-building network 203 may be entirely interconnected. However, the user-building network 203 may not need to be entirely interconnected. Consider the association between User H 205h and Building 7 206g, where there is building related data forming an association between User H 205h and Building 7 206g; but User H 205h has no building related data with another physical real world building, and Building 7 206g does not have any building related data from any other user. Further, for example, a user or a physical real world building of the user-building network 203 may be entirely independent of any other physical real world buildings or users (such as User I 205i and Building 8 206h, where User I 205i has no building related data for any physical real world building and Building 8 206h has no building related data from any user).

In one exemplary embodiment, a user-building network 203 comprises users and physical real world buildings wherein physical real world buildings are only associated with users and users are only associated with physical real world buildings. Again, the illustrated associations are formed based on the relationships between the building related data associated with users and physical real world buildings. Nevertheless, it will be understood that in alternate embodiments, users may also be associated with other users, and physical real world buildings may also be associated with other physical real world buildings.

The user-building networks 200, 201, 202 and 203 are illustrative of example embodiments and any actual user-building networks may be more complex and non-static, with an unlimited and changing number of users, an unlimited and changing number of physical real world buildings and an unlimited amount of building related data.

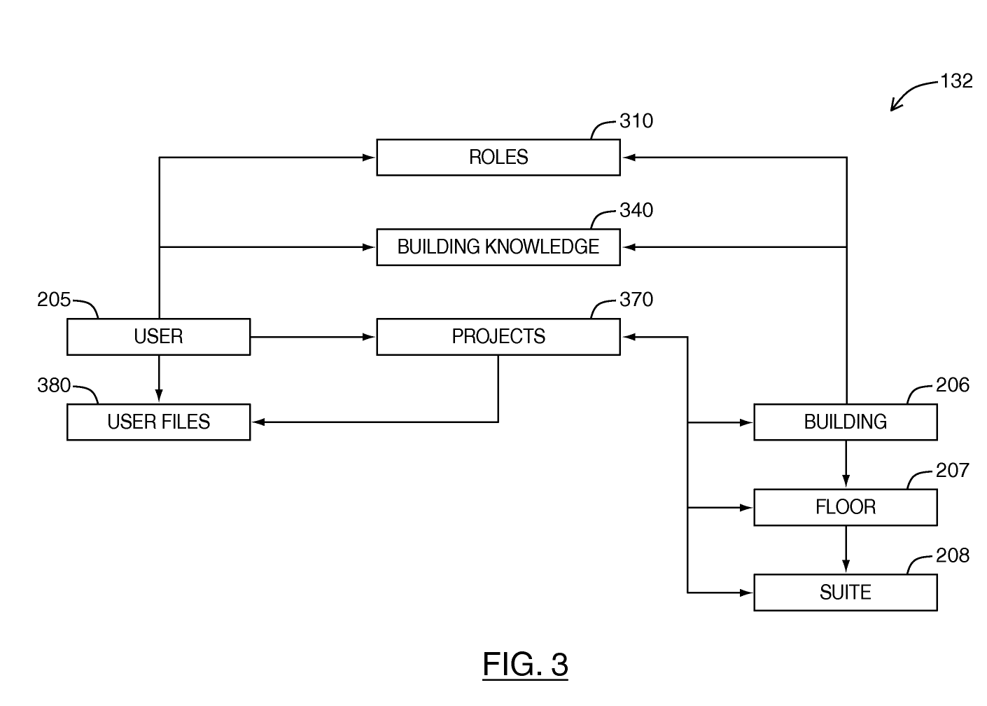

Referring to FIG. 3, there is shown a block diagram of the relationships between data elements in the contents of building database 132 in one example implementation, shown generally as 132. Building database 132 is a model of real world physical objects as well as of relationships between real buildings and real people. It will be understood by those skilled in the art that references to real world physical objects below may also refer to their representations in building database 132.

Building database 132 may include at least one user 205. In one embodiment there are two types of users 205: a standard user and an administrator. Administrators may have full control over the building database 132 but may be limited to a plurality of buildings 206. In one embodiment the administrator may be limited geographically. Anyone can apply to be a standard user of the building database 132, for example, by using a web form. In order to become a standard user an administrator must approve the potential user's application. In a further embodiment, the standard user must apply and be approved for roles 310 on the building.

Roles 310 determine the authorization level to access at least some building related data. There are many different types of roles 310 for a user 205, and each user 205 can have a different role 310 for different projects 370, buildings 206, floors 207, suites 208 and user files 380.

A special role 310 is that of an administrator. An administrator allows for management of the system, to make changes and apply roles and authorization levels to other users 205 and buildings 206.

Another type of role 310 is a landlord, where a landlord is a person or company who owns or manages real world physical space (e.g., building 206, floor 207, or suite 208). In one embodiment the administrator is the only user 205 able to assign the role 310 of landlord to another user 205. A landlord can assign other roles 310 to other users 205 on the building 206 for which they are landlord. A landlord can add, edit, and delete building knowledge 340 and projects 370. As will be discussed below, a landlord can control the degree of public content in building knowledge 340 and projects 370.

Another type of role 310 is a real estate broker, where a real estate broker could be a listing agent: a person or company that actively leases space in the real world physical building 206; or a tenant agent: a person or company who works on behalf of prospective tenants.

For example, one type of role 310 is a consultant. In one embodiment the administrator and the landlord are the only users that can assign the role 310 of consultant to a user 205. A user 205 with the role 310 of a consultant can add building knowledge 340, projects 370, and user files 380. A consultant can control the visibility and access to the building knowledge 340, projects 370, or user files 380 that the consultant has contributed.

A consultant may comprise an interior designer; a person or company that designs layouts and changes of the interior configuration of the real world physical building 206. A consultant may also comprise an architect; a person or company that designs layouts and changes of the interior and exterior configuration of the real world physical building 206. The architect may be the original designer of the real world physical building 206 and/or may be involved in subsequent changes and updates of the real world physical building 206.

A consultant may also be a mechanical engineer; a person or company that designs the layout of mechanical services such as the air handling equipment for the real world physical building 206. The mechanical engineer may be the original designer of the real world physical building 206 and/or may be involved in subsequent changes and updates of the real world physical building 206.

A consultant may also be an electrical engineer; a person or company that designs the electrical systems in the real world physical building 206. The electrical engineer may be the original designer of the real world physical building 206 and/or may be involved in subsequent changes and updates of the real world physical building 206.

A consultant may also be a structural engineer; a person or company that is responsible for the design of structural elements in the real world physical building 206. The structural engineer may be the original designer of the real world physical building 206 and/or may be involved in subsequent changes and updates of the real world physical building 206.

Another type of role 310, for example, is a contractor. A contractor is a person or company that has done construction work on the real world physical building 206. This role 310 may be further sub-divided amongst various specialized trades.

Another type of role 310, for example, is a supplier. A supplier is a person or company that provides products or services required in the operation, maintenance, or renovation of the real world physical building 206.

Another type of role 310, for example, is a tenant. A tenant is a person or company that rents space in or occupies the real world physical building 206.

Another type of role 310, for example, is a contributor. A contributor is a person or company that chooses to contribute knowledge to the building 206 even though they have no other direct interest in the real world physical building 206. The role 310 of contributor can be assigned or approved to a user 205 by a landlord or an administrator. In one embodiment, a contributor can only add building knowledge and cannot contribute projects 370 or user files 380.

Roles 310 are not limited to the above-described examples and can comprise any type of relationship a user 205 may have with a building.

Building database 132 may further comprise at least one physical real world building 206. A physical real world building 206 comprises basic information about the physical real world building, for example; address, longitude and latitude, number of floors, area and usage. A physical real world building 206 can be related to at least one project 370, building knowledge 340 and/or user file 380 [relationship not shown].

Physical real world building 206, in one embodiment, comprises at least one floor 207. A floor 207 comprises, for example, a floor name and a sort order within the building 206. A floor 207 may contain area information, gross-up factors and elevation information, for example. A floor 207 can be related to at least one project 370, building knowledge 340 [relationship not shown] and/or user file 380 [relationship not shown].

Floor 207, in one embodiment, may comprise at least one suite 208. Suite 208 comprises, for example, a suite name and sort order within the floor 207. A suite 208 may contain area information and amenities description, for example. A suite 208 can be related to at least one project 370, building knowledge 340 [relationship not shown] and/or user file 380 [relationship not shown].

Building database 132 may comprise at least some building knowledge 340. Building knowledge 340 can be contributed to by users 205 with an appropriate role 310. Building knowledge 340, for example, comprises basic historical information and photos about the real world physical building. A user 205 that contributes building knowledge 340 can edit and delete that building knowledge 340. A user with a role 310 such as landlord of a building 206 can edit and delete any building knowledge 340 related to that building 206.

Building database 132 may comprise at least one project 370. Projects 370 represent work done in the building whether in tenant space or as part of tenant improvement work. Users with roles 310 such as landlords or consultants can create and edit projects 370. A user with a role 310 such as landlord can edit and delete any project 370, as well as limit publicly viewable details, such as specific location and tenant information. Projects 370 can be related to several roles 310, such as consultants. For example, there may be a mechanical engineer, a supplier as well as an electrical engineer on one project 370.

Building database 132 may comprise at least one user file 380. A user file 380 comprises any document that represents building related data. A user file 380 may refer to a document that has been uploaded to the building database 132, or a user file 380 may contain a link, for example, a URL for the location of the file somewhere else on the web, or a user file 380 may indicate the existence of a document and provide the contact information as to whomever can produce the document. A user file 380 is specific to various levels of detail within a real world physical building. A user file 380 can be related to a project 370 for a building 206, a floor 207, and/or a suite 208.

In one embodiment a user file 380 could comprise, for example, a CAD file; an electronic drawing in two-dimensions (2D); an electronic drawing in three-dimensions (3D); a scanned document of construction drawings; a technical document; a technical specification; a building permit; a building permit related document; a current photograph; a historical photograph; map based information; a contract; a lease; a survey drawing; survey data; or any other building related data. While such data may pertain to construction, it will be understood that building related data may include other data not related to construction.

In one embodiment access to user files 380, buildings 206, floors 207, suites 208, building knowledge 340 and projects 370 is managed by the owners of the real world content. The user 205 that owns the copyright to the content in the building database 132 controls the authorization level to access that content. For example, a user 205 with the role 310 consultant controls the content that was contributed by them. Control of the content comprises, for example, authorizing what another user 205 can access: what user files 380 and what projects 370.

In one embodiment a user 205 with the role 310 of landlord can control all aspects of the data associated to a physical real world building, for example building knowledge 340, roles 310 of users 205, and public details of projects 370 for that building 206. For example a user 205 with the role 310 of landlord can force tenant names and specific locations of physical real world buildings to remain private.

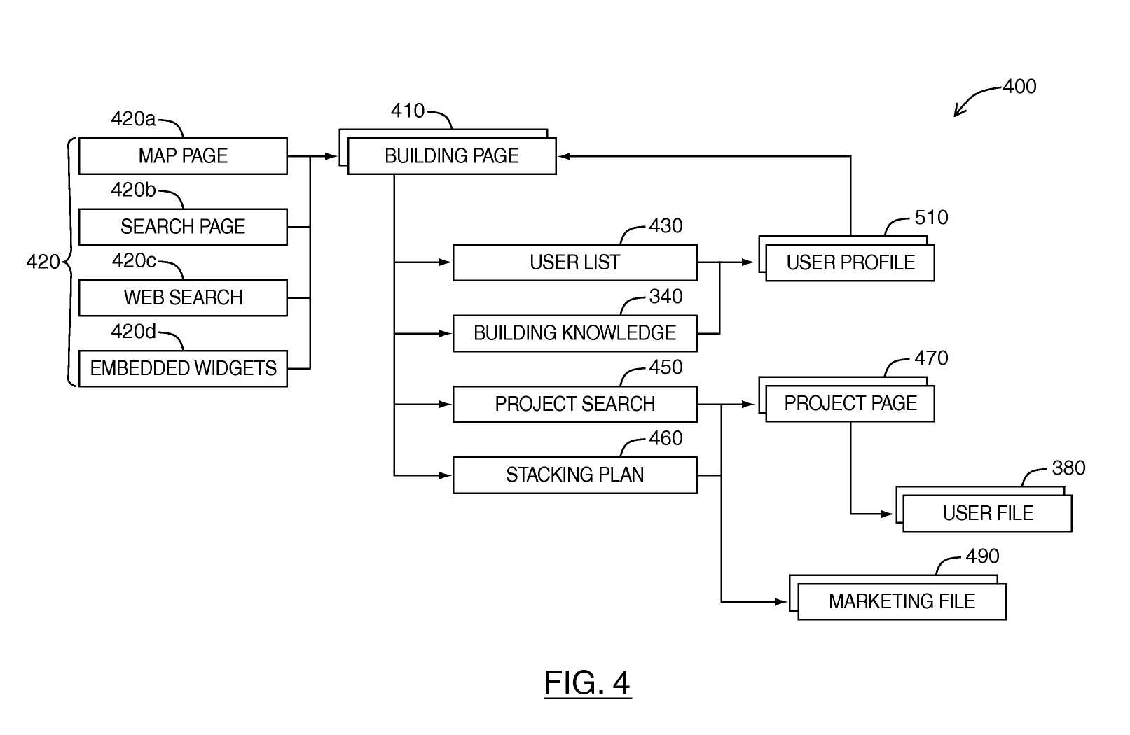

Referring to FIG. 4, therein illustrated is a block diagram of a sample navigation flow, shown generally as 400, of exemplary web-based building information application 130. Specifically, navigation flow 400 shows navigation by building. It will be understood by those skilled in the art that navigation flow 400 may be constructed using web-based technologies (such as, PHP: Hypertext Preprocessor (PHP) and a database supporting a structured query language (e.g., MySQL)) to access building database 132 to create the webpages discussed below (referred to simply as “pages”). It will be further understood that such pages may be statically stored or dynamically generated upon user request based on information stored in building database 132.

Each physical real world building may be represented by a set of sub-pages. The building information application 130 may comprise at least one building page 410 that represents a physical real world building. The building page 410 includes building related data, for example, photos, map locations and basic building descriptions. In one embodiment the building page 410 has a unique URL.

A user may navigate to building page 410 in at least one of a plurality of reference mechanisms shown generally as 420. For example, the building page 410 may be arrived at via a map page 420a, a search page 420b. a conventional web search 420c, or an embedded widget 420d. An embedded widget 420d, for example, can be configured to appear on a user's personal website. It will be understood by those skilled in the art that building page 410 may be arrived at by any other method for arriving at particular Uniform Resource Locator (URL) addresses.

The building page 410 provides access to more building detail in the sub-pages. The sub-pages may, for example, comprise in at least one embodiment, one or more of: a user list 430, building knowledge 340, project search 450 and stacking plan 460.

The user list 430 comprises a list of user profiles 510 that have building related data, such as project information or building knowledge 340 for the physical real world building represented by building page 410.

As discussed earlier, building knowledge 340 comprises general information about the physical real world building, such as history and amenities. This building knowledge 340, in one embodiment, can be compiled for example, in a collaborative type of website (e.g. through the use of Wiki software) that allows the easy creation and editing of interlinked web pages. Users contribute this building knowledge 340. When this occurs, the building knowledge 340 is linked to a user profile 510 so that the user that contributed the building knowledge 340 is identified.

The project search 450 comprises a search function for building related data, specifically project information for the physical real world building 206 represented in the building database 132 by the building page 410. In one embodiment the project search 450 is a simple search allowing users to find project information based on keywords or physical location for the real world building 206. The project search 450 can be linked to the source of the building related data, such as the project page 470.

The stacking plan 460 displays building related data such as spatial and area information for the physical real world building 206 represented in the building database 132 by the building page 410. The stacking plan 460, in one embodiment, comprises a multi-dimensional chart created to display the arrangement of tenants in the physical real world building. The stacking plan 460 can be linked to the source of the building related data, such as the project page 470 or marketing file 490.

The marketing file 490, for example, may comprise any information that the landlord or agent wishes to make public or widely available. The purpose of the file may be to describe the available space and may include photographs, drawings and renderings in 2D or 3D as well as movies and walk-throughs that can either be recorded using a camera or rendered using software.

The project page 470 comprises project information. In one embodiment, a project can be a change that has been made to the physical real world building. The project page 470 also comprises user files 380 that are related to project information. The project page 470 is linked to a user profile 510 who has contributed building related data for the physical real world building represented by building page 410.

As discussed earlier, user file 380 comprises building related data that is generated as a result of the project. In one embodiment, the user files 380 are editable. In one exemplary embodiment, the user files 380 are computer aided design (CAD) files. In a further exemplary embodiment, the user files 380 are three-dimensional (3D) models. In another embodiment, the user files 380 may be securely uploaded to building database 132 and references can be entered as to which users have copies of the user files 380.

It will be understood that the owner of a user file 380 may designate the accessibility of their documents. For example, they may choose to upload the document and make it available to the public, upload the document and provide access only to certain users (sometimes in exchange for payment), or not upload the document at all and just provide information on how to ask for access. Having provided access to a user file 380, the owner may also be able to provide copyright information, licensing information and terms of use for their document. The owner may further employ Digital Rights Management (DRM) technology to enforce such legal restrictions.

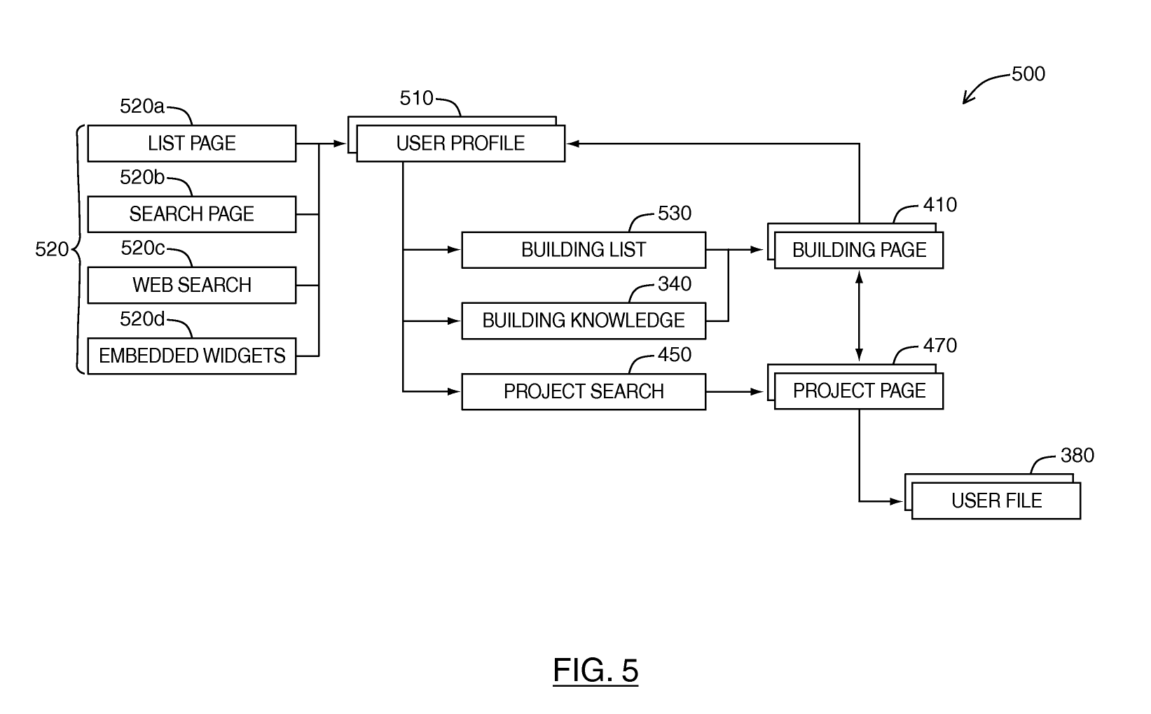

Referring to FIG. 5, therein illustrated is a block diagram of an alternate sample navigation flow, shown generally as 500, of an exemplary web-based building information application 130. Whereas navigation flow 400 uses real world physical buildings 206 (represented by building page 410) as a starting navigation point, navigation flow 500 illustrates navigation starting with user 205 (represented by user profile 510). User profile 510 comprises user related data, for example, a professional profile and a professional resume. In one embodiment the user profile 510 has a unique URL.

In one embodiment, user 205 may control access to their user profile 510. For example, user 205 may make their user profile 510 fully public, fully private, or viewable only by other selected users of building information application 130. Moreover, user 205 may also be able to choose nicknames for their user profile 510 so as to protect their privacy. In another embodiment, the user may control, using various authorization levels, the building related data controlled by user profile 510.

The user profile 510 may be navigated to in at least one of a plurality of reference mechanisms, shown generally as 520. In an at least one embodiment the user profile 510 may be arrived at via a list page 520a. In an at least one other embodiment, the user profile 510 may be arrived at via a search page 520b. In an at least one other embodiment, the user profile 510 may be arrived at via a conventional web search 520c. In an at least one other embodiment the user profile 510 may be arrived at via an embedded widget 520d. The embedded widget 520d, for example, can be organized to appear on a building's external website. In another embodiment the user profile 510 may be arrived at by any other method for arriving at particular URL addresses. In one embodiment, the user can control, using various authorization levels, how a user profile 510 is navigated to.

The user profile 510 provides access to more building detail in the sub-pages. The sub-pages may, for example, comprise in at least one embodiment any one or more of: a building list 530, building knowledge 540, and project search 450.

The building list 530 comprises a list of building pages 410 that have building related data contributed by the user represented by the user profile 510, such as project information or building knowledge 540 for the physical real world building represented in building database 132 by the building page 410.

Building knowledge 340 may contain the same characteristics as described above. However, in addition or alternatively, in this context, building knowledge 340 may be linked to a building page 410 identifying the physical real world building that the building knowledge 340 pertains to.

The project search 450 comprises a search function for building related data. In this context, project search 450 searches for project information for physical real world building 206 contributed by the user represented by the user profile 510. As discussed earlier, in one embodiment the project search 450 may be a simple search allowing users to find project information based on keywords or by searching by building addresses. The project search 450 may be linked to the source of the building related data, such as the project page 470.

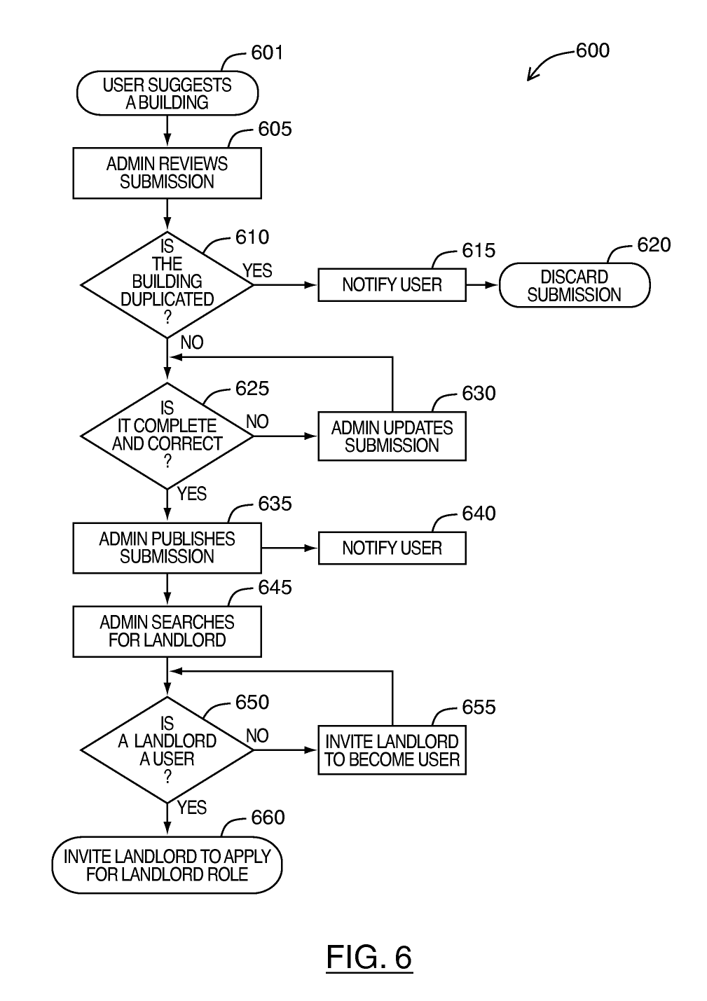

Further details of a number of embodiments will now be provided with reference to FIGS. 6 to 8. Each of FIGS. 6 to 8 illustrates the steps of a method in accordance with at least one embodiment. For purposes of illustration, the methods will be described in the context of how it may be carried out by the building information system 102 depicted in FIG. 1. It will be understood that even though processor 120 or the administrator has been indicated as performing steps in the methods of FIGS. 6 to 8, alternate embodiments may allow all or portions of such steps to be performed manually either by the administrator or another user. In further alternate embodiments, all or portions of such steps may be automated and performed by processor 120 in building information system 102 or another processor in another computer system capable of performing such steps.

Referring to FIG. 6, the method 600 illustrates an example embodiment of how a building is added to the building database 132. At 601 the building information system 102 receives a submission to add a building to the building database 132. An administrator then reviews the submission at 605. Next at 610 the processor 120 determines if the building is duplicated. If the building is duplicated the processor 120 will notify the user (615) then discard the submission (620). If the building is not duplicated the processor 120 will determine if the submission is complete and correct at 625. If the submission is not complete the administrator will update the submission at 630 and the processor will return to step 625. If the submission is complete and correct the administrator will publish the submission (635) and notify the user (640).

Next, at 645, the administrator will search for a landlord of the physical real world building. The processor 120 will determine if the landlord found by the administrator is a user at 650. If the landlord is not a user the processor 120 will invite the landlord to become a user (655) If the landlord is a user the processor 120 will invite the landlord to apply for the landlord role at 660.

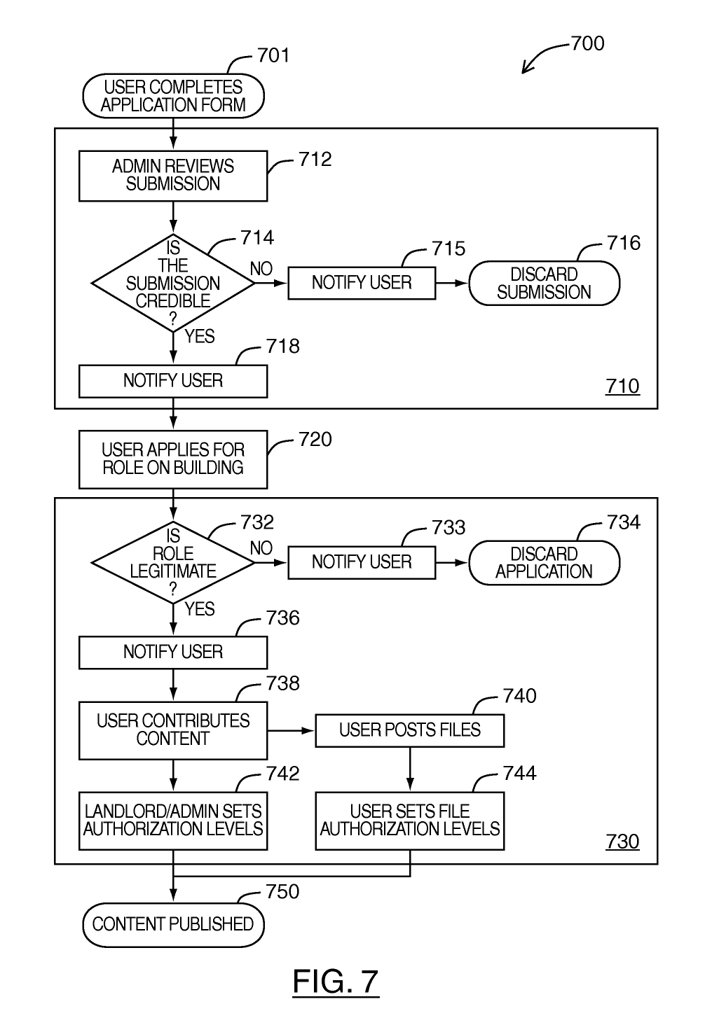

Referring now to FIG. 7, the method 700 illustrates an example embodiment of how a user accesses and contributes building related data. At 701, the user completes the application form. An administrator reviews the submission next at 712. The administrator then determines whether the submission is credible (714). If the administrator determines that the submission is not credible the user is notified (715) and the submission is discarded (716). If the administrator determines that the submission is credible the user is notified (718). Note that in certain embodiments an administrator controls authorization and access for the tasks of 710.

Next at 720, the user applies for a role on a building. At 732, the landlord determines if the applied-for role is legitimate, if no landlord role has been assigned the administrator determines if the applied-for role is legitimate. If the applied-for role is determined not to be legitimate the user is notified (733) and the application is discarded (734). If the applied-for role is determined to be legitimate the user is notified (736), and the user contributes content (738), posts user files (740) and sets user file authorization levels (744). The landlord or administrator sets the authorization levels for the contributed content (742). Ultimately the content is published (750). Note that in certain embodiments a landlord or, where there is no landlord role assigned for the building, an administrator, controls authorization and access for the tasks of 730.

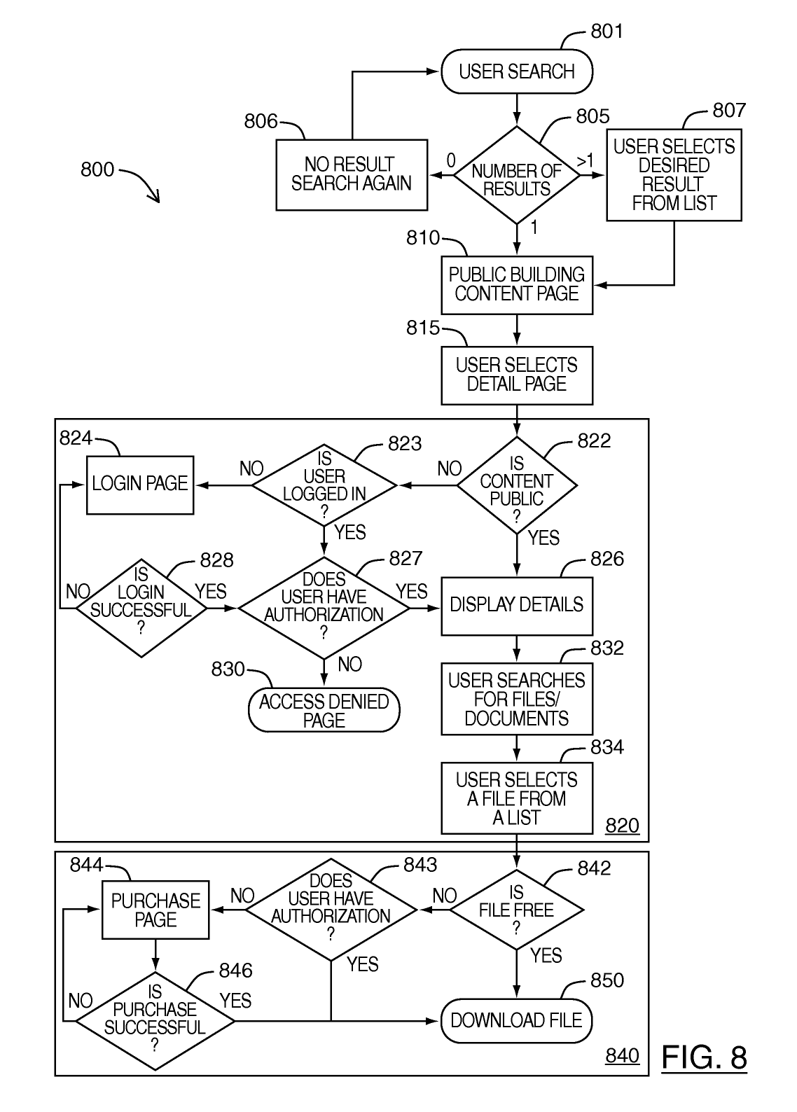

Referring now to FIG. 8, the method 800 illustrates an example embodiment of how a user may access and obtain building related data. At 801 the user, for example, searches for a desired piece of data. At 805 the processor 120 searches the building database 132 to determine the number of results that match the users search criteria. If there are no results, the processor 120 will prompt the user to search again (806). If there is exactly one result the processor 120 will display the public building page (810). If there is more than one result the user will select the desired result from a list of results (807), then the processor 120 will display the public building page (810). The user will then select a sub page (815).

Next, at 822 the processor 120 will determine if the content in the sub page is public. If the content in the sub page is determined not to be public, the processor 120 will determine if the user is logged in (823). If the user is not logged in, the processor 120 will take the user to the login page (824). The processor 120 will then determine if the login is successful (828). If the login is not successful the user will return to the login page (824). If the login is successful or if the user is logged in the processor will determine if the user has authorization (827). If the user does not have authorization, the processor 120 will display the access denied page (830). If the user does have access or the content is public the processor 120 will display the content of the sub page (826). The user will search for building related data at 823. The user then selects the desired building related data from a list at 834. Note that in certain embodiments a landlord or, where there is no landlord role assigned for the building, an administrator, controls authorization and access for the tasks of 820.

Next, at 842 the processor 120 determines if the selected building related data is free. If the processor 120 determines that the user file is not free, the processor 120 determines if the user has authorization (843). If the user does not have authorization, the processor 120 will direct the user to the purchase page (844). The processor 120 will then determine if the purchase has been successful (846). Once the purchase is successful, or if the user has permission, or if the user file is free, the processor 120 will download the building related data to the user. It should be noted that in certain embodiments the owner of the user file controls authorization and access for the tasks of 840.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A system for exchanging building related data associated with a physical real world building amongst a first and second user, said system comprising:
(a) a processor;
(b) a building database for storing and maintaining the building related data associated with a physical real world building; and
(c) a physical computer readable memory storing computer executable instructions which, when executed by the processor causes the processor to:
(i) associate the first user with the physical real world building;
(ii) associate the second user with the physical real world building;
(iii) provide the first user and the second user with an authorization level to access the building database;
(iv) determine whether the authorization level of the first and second users allows them to access at least some of the building related data associated with the physical real world building;
(v) if in (iv) access is authorized, allow the exchange of building related data between a first user and a second user based on their mutual association through the physical real world building.

2. The system of claim 1, wherein the building related data is building related data.

3. The system of claim 1, wherein the first and second users are each provided with an authorization level in (i) and (ii) based on the role of each of the first and second user in respect of the real world physical building.

4. The system of claim 3, wherein the determination in (iv) is based on determining whether the roles of the first and second users in respect of the physical real world building permits access to at least some of the building related data.

5. The system of claim 1, wherein the first user establishes the authorization level of the second user.

6. The system of claim 1, wherein the building related data is existing data, and the physical real world building is an existing building.

7. The system of claim 1, wherein the processor manages the digital rights of the building related data.

8. The system of claim 3, wherein the role is selected from a group consisting of but not limited to: landlord, real estate broker, consultant, contractor, supplier, tenant, contributor, and administrator.

9. The system of claim 1, wherein the building related data is selected from a group consisting of but not limited to:
(i) CAD files and other electronic drawings in 2D and 3D
(ii) Scanned documents and construction drawings
(iii) Technical documents and specifications
(iv) Building permits and related documents
(v) Current photographs
(vi) Historical photographs
(vii) Map based information
(viii) Contracts or leases
(ix) Survey drawings and data

10. The system of claim 9, where the building related data can be edited.

11. A method of exchanging building related data associated with a physical real world building amongst a first and second user, the steps of said method being performed by a processor, the method comprising:
(a) storing and maintaining a building database for the building related data associated with a physical real world building;
(b) associating the first user with the physical real world building;
(c) associating the second user with the physical real world building;
(d) providing the first user and the second user with an authorization level to access the building database;
(e) determining whether the authorization level of the first and second users allows them to access at least some of the building related data associated with the physical real world building;
(f) wherein, if in (e) access is authorized, allowing the exchange of building related data between a first user and a second user based on their mutual association through the physical real world building.

12. The method of claim 11, wherein the first and second users are each provided with an authorization level in (b) and (c) based on the role of each of the first and second user in respect of the real world physical building.

13. The method of claim 12, wherein the determination in (e) is based on determining whether the roles of the first and second users in respect of the physical real world building permits access to at least some of the building related data.

14. The method of claim 11, wherein the first user establishes the authorization level of the second user.

15. The method of claim 11, wherein the building related data is existing data, and the physical real world building is an existing building.

16. The method of claim 11, further comprising managing the digital rights of the building related data.

17. The method of claim 12, wherein the role is selected from a group consisting of: landlord, real estate broker, consultant, contractor, supplier, tenant, contributor, and administrator.

18. The method of claim 11, wherein the building related data is selected from a group consisting of: CAD files and other electronic drawings in 2D and 3D
(i) Scanned documents and construction drawings
(ii) Technical documents and specifications
(iii) Building permits and related documents
(iv) Current photographs
(v) Historical photographs
(vi) Map based information
(vii) Contracts or leases
(viii) Survey drawings and data

19. The method of claim 18, where the building related data can be edited.

20. A physical computer-readable medium upon which a plurality of instructions are stored, the instructions for performing the steps of the method as claimed in claim 11.
